(19) United States
(12) Patent Application Publication
(10) Pub. No.: US 2012/0218771 A1
(43) Pub. Date: Aug. 30, 2012

(54) SOLAR POWER BICYCLE LIGHT ASSEMBLY COOPERATED WITH ALKALINE BATTERY

(76) Inventor: Yu Chi YEN, Changhua County (TW)

(21) Appl. No.: 13/033,604

(22) Filed: Feb. 24, 2011

(51) Int. Cl. B62J 6/02

(52) U.S. Cl. 362/473

(57) ABSTRACT

A bicycle light assembly includes a case having a light unit connected to a front end thereof and a solar panel is connected to a top of the case. Multiple batteries are received in the case and electrically connected with the solar panel. A connection unit is connected to an underside of the case and connected to a handlebar of a bicycle. The solar panel absorbs the solar energy which is transferred into electric power to be stored in the batteries such that the batteries have longer life of use.

### FIELD OF THE INVENTION

The present invention relates to a bicycle light assembly having a solar panel for transferring solar energy into electric power which is stored in the alkaline battery to power the light assembly.

### BACKGROUND OF THE INVENTION

Cycling becomes a type of life during the past couple years and the people love to use bicycles to be one of the options of transportation and exercises. However, safety is always the first concern when operating the bicycles and the light assembly is one of the top optional choices of the bicycles. The light assembly is assembled to the frame of the bicycle and provides illumination to see the roads and also allow the cyclist to be seen by others. Most of the conventional bicycle light assemblies are powered by batteries which have limited lift of use so that the batteries have to be replaced frequently. The discarded batteries become a serious environmental problem.

The present invention intends to provide a bicycle light assembly which includes a solar panel for absorbing solar energy which is transferred to electric energy via the batteries so that the users can use the solar energy to power the light assembly and the batteries are able to be used for a longer period of time.

### SUMMARY OF THE INVENTION

The present invention relates to a bicycle light assembly and comprises a case having a light unit connected to the front end thereof and a solar panel is connected to the top of the case. Multiple batteries are received in the case and electrically connected with the solar panel. A connection unit is connected to the underside of the case and connected to the handlebar of a bicycle. The solar panel absorbs the solar energy which is transferred into electric power to be stored in the batteries such that the batteries have longer life of use.

Preferably, the case includes a room defined in the underside thereof so as to receive the batteries therein and a cover is engaged with the underside of the case and seals the room.

Preferably, the case has an engaging member extending from the underside thereof having a bent portion. The cover has an engaging recess which is located corresponding to the engaging member.

Preferably, the cover has a rail on an underside thereof and the rail includes a free distal end. A notch is defined in the underside of the rail. The connection unit includes a slot and the rail is slidably engaged with the slot. A protrusion extends from the inner surface thereof and is engaged with the notch when the rail is engaged with the slot.

Preferably, the connection unit comprises a flexible plate extending from the inner surface of the slot and the protrusion is located on the flexible plate. An operation portion extends from the flexible plate at an angle.

Preferably, the connection unit comprises two arms which clamp the handlebar and a fastening member extends through the two arms to pull the two arms toward each other.

Preferably, the case has a switch connected to the underside thereof and located close to the light unit. The switch controls the operation of the solar panel.

The primary object of the present invention is to provide a light assembly for a bicycle wherein the solar panel absorbs the solar energy and the solar energy is transferred into electric power to be stored in the batteries such that the batteries have longer life of use.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the bicycle light assembly of the present invention;

FIG. 2 is an exploded view to show the bicycle light assembly of the present invention;

FIG. 3 is another exploded view to show the bicycle light assembly of the present invention, and

FIG. 4 shows that the bicycle light assembly of the present invention is connected to the handlebar of a bicycle.

### DETAILED DESCRIPTION OF THE PREFERRED EMBODIMENT

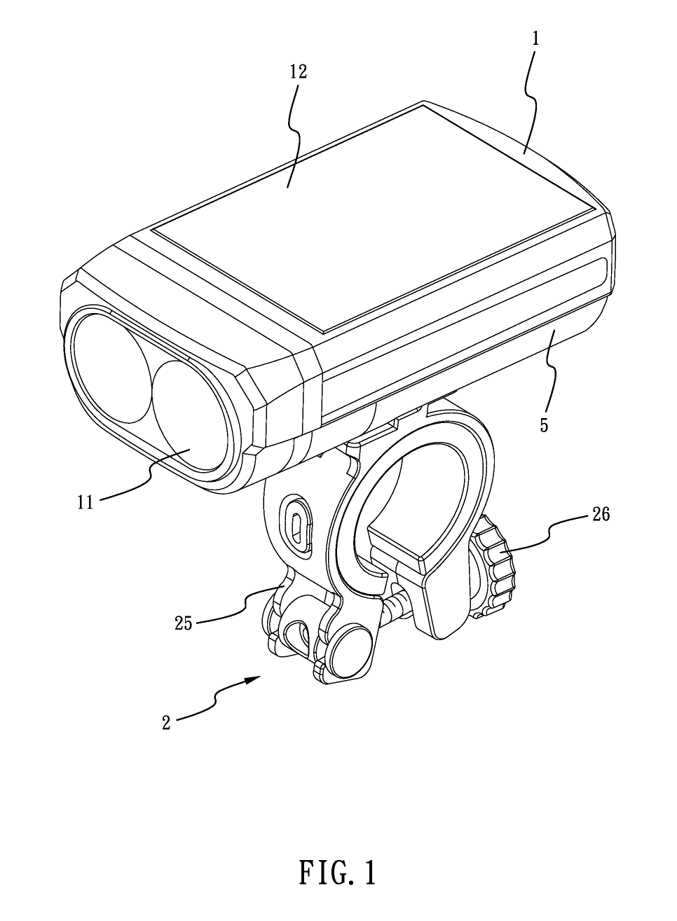

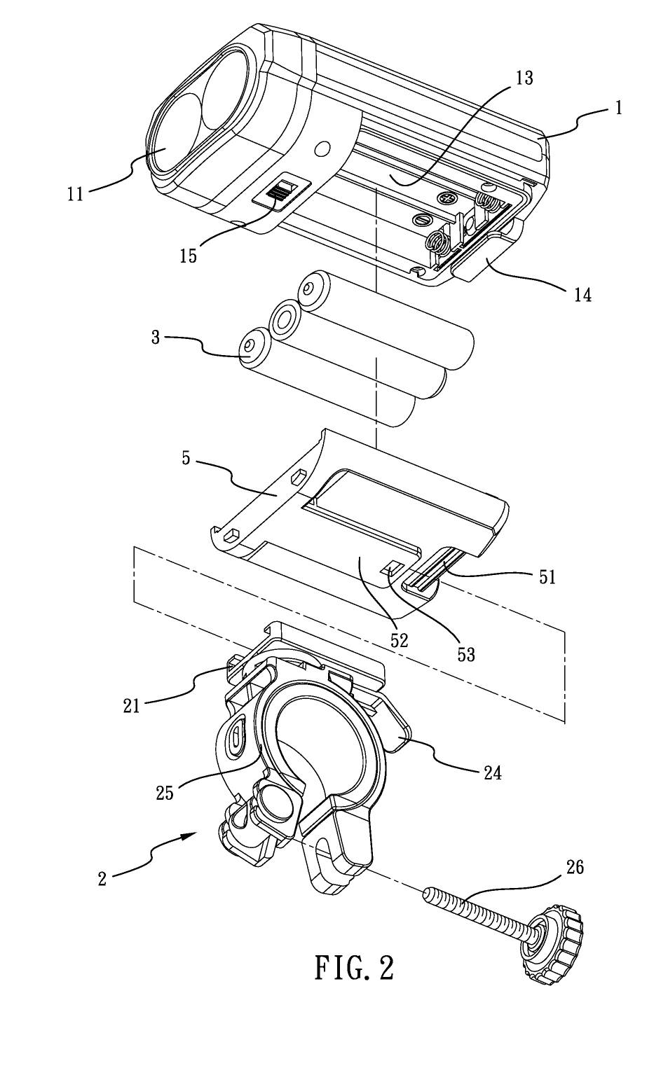

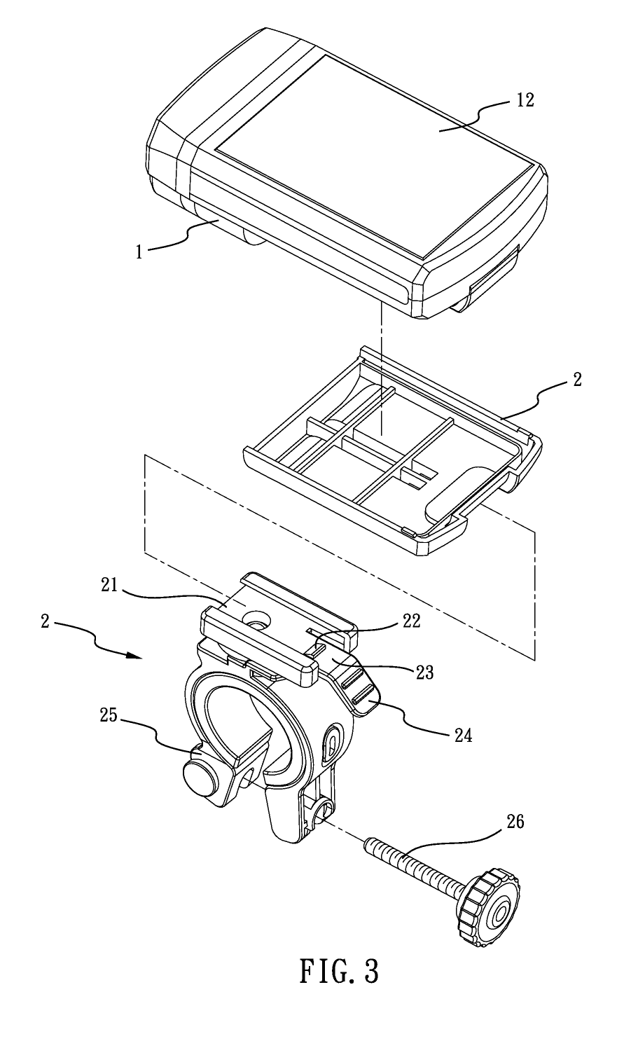

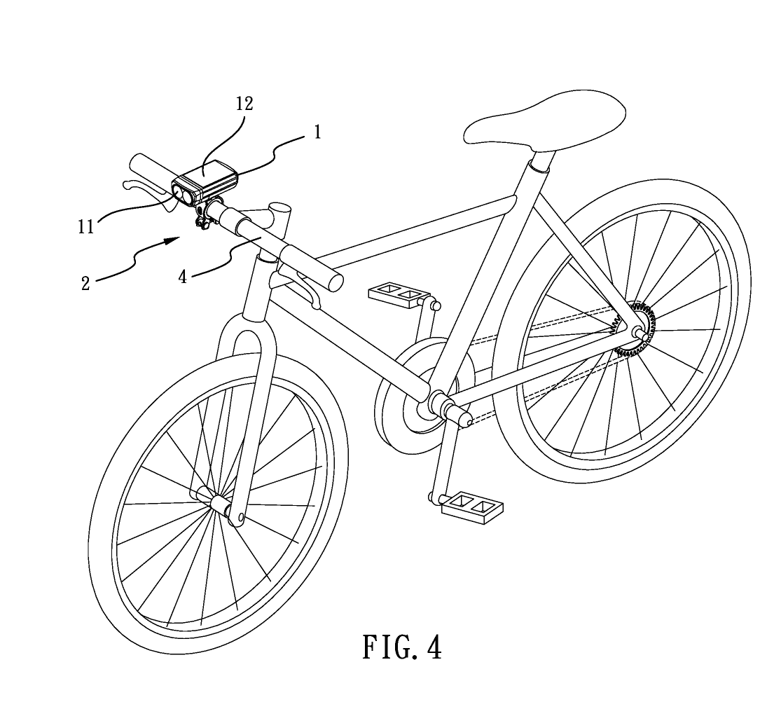

Referring to FIGS. 1 to 4, the bicycle light assembly of the present invention comprises a case 1 and a connection unit 2, wherein the case 1 comprises a light unit 11 connected to the front end thereof and a solar panel 12 is connected to the top of the case 1. The size of the solar panel 12 is slightly smaller than the area of the top of the case 1. The light unit 11 can be Light Emitting Diodes or conventional tungsten light bulbs. Multiple batteries 3 are received in the case 1 and electrically connected with the solar panel 12. The connection unit 2 is connected to the underside of the case 1 and connected to the handlebar 4 of a bicycle.

The case 1 includes a photoelectric conversion circuit (not shown) which is connected between the batteries 3 and the solar panel 12 so that the solar energy is absorbed by the solar panel and transferred into electric power to be stored in the batteries 3.

The case 1 includes a room 13 defined in the underside thereof and the room 13 is located close to a rear end of the case 1. The batteries 3 are received in the room 13. A cover 5 is engaged with the underside of the case 1 and seals the room 13. An engaging member 14 extends from the underside of the rear end of the case 1 and has a bent portion which extends toward the front end of the case 1. The cover 5 has an engaging recess 51 which is located corresponding to the engaging member 14. The case 1 further has a switch 15 connected to the underside thereof and located close to the light unit 11.

The cover 5 has a rail 52 on the underside thereof which extends from the front end of the case 1 toward the rear end of the case 1. The rail 52 includes a free distal end. A notch 53 is defined in an underside of the rail 52. The connection unit 2 includes a slot 21 and the rail 52 is slidably engaged with the slot 21. A protrusion 22 extends from the inner surface of the rail 52 and is engaged with the notch 53 when the rail 52 is engaged with the slot 21.

The connection unit 2 comprises a flexible plate 23 extending from the inner surface of the slot 21 and the protrusion 22 is located on the flexible plate 23. An operation portion 24 extends from the flexible plate 23 at an angle. The connection unit 2 comprises two arms 25 which clamp the handlebar 4 by extending a fastening member 26 extends through the two arms 25 to pull the two arms 25 toward each other to fix the connection unit 2 to the handlebar 4.

The solar panel 12 on the top of the case 1 absorbs the solar energy which is transferred into electric power by the photoelectric conversion circuit and the electric power is stored in the batteries 3 such that the batteries 3 power the light unit 11.

The alkaline batteries 3 can be indirectly powered by the solar energy so that they do not need to be replaced frequently.

Furthermore, the switch 15 is electrically connected with the photoelectric conversion circuit to control the activation of the light unit 11 and the charging modes of the solar panel 12, or to control that the light unit 11 is powered by the batteries 3 and stop using the solar panel 12.

When the user pushes the operation portion 24, the flexible plate 23 is pushed downward so that the protrusion 22 is disengaged from the notch 53 of the cover 5, and the cover 5 can be easily removed from the case 1.

While we have shown and described the embodiment in accordance with the present invention, it should be clear to those skilled in the art that further embodiments may be made without departing from the scope of the present invention.

What is claimed is:

1. A bicycle light assembly comprising:
a case having a light unit connected to a front end thereof and a solar panel connected to a top of the case, multiple batteries received in the case and electrically connected with the solar panel, and
a connection unit connected to an underside of the case and adapted to be connected to a handlebar of a bicycle.

2. The assembly as claimed in claim 1, wherein the case includes a room defined in an underside thereof and the room is located close to a rear end of the case, the batteries are received in the room, a cover engaged with the underside of the case and seals the room.

3. The assembly as claimed in claim 2, wherein the case has an engaging member extending from the underside of the rear end thereof and the engaging member has a bent portion which extends toward the front end of the case, the cover has an engaging recess which is located corresponding to the engaging member.

4. The assembly as claimed in claim 3, wherein the cover has a rail on an underside thereof which extends from the front end of the case toward the rear end of the case, the rail includes a free distal end, a notch is defined in an underside of the rail, the connection unit includes a slot and the rail is slidably engaged with the slot, a protrusion extends from an inner surface thereof and is engaged with the notch when the rail is engaged with the slot.

5. The assembly as claimed in claim 4, wherein the connection unit comprises a flexible plate extending from the inner surface of the slot and the protrusion is located on the flexible plate, an operation portion extends from the flexible plate at an angle.

6. The assembly as claimed in claim 1, wherein the connection unit comprises two arms which are adapted to clamp the handlebar, a fastening member extends through the two arms to pull the two arms toward each other.

7. The assembly as claimed in claim 1, wherein the case has a switch connected to an underside thereof and located close to the light unit.
